(19) United States
(12) Patent Application Publication
(10) Pub. No.: US 2008/0187885 A1
(43) Pub. Date: Aug. 7, 2008

(54) ONE HANDLE ORAL EXTRACTION DEVICE WITH VARIABLE CLEARANCES BETWEEN HOOK AND PAD SUPPORT PORTIONS

(76) Inventor: Richard Golden, Detroit, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/026,213

(22) Filed: Feb. 5, 2008

Related U.S. Application Data
(60) Provisional application No. 60/888,261, filed on Feb. 5, 2007.

(51) Int. Cl. A61C 3/14

(52) U.S. Cl. 433/159

(57) ABSTRACT

The present invention relates generally to an extraction or pliers type device, such as typically utilized by a dentist or oral surgeon. One or more individual devices are provided which establish a variable clearance established between a hook engaging portion and an offset and opposing arrayed pad support portion. A kit can establish a plurality of fixed items exhibiting the varying clearances. Alternatively, the hook engaging and pad support portions can be integrated into one or two separate components which are engaged with a further handle component.

### CROSS-REFERENCE TO RELATED APPLICATIONS

This Application is a Non-Prov of Prov.(35 USC 119(e)) application 60/888,261 filed on Feb. 5, 2007 and entitled One-Handle Oral Extraction Device.

### FIELD OF THE INVENTION

The present invention relates generally to an extraction device, such as typically utilized by a dentist or oral surgeon. More specifically, the present invention teaches an extraction device exhibiting a single handle body terminating at an end location in a hooked engaging portion which exhibits a generally beak shape. In a first embodiment, a widthwise extending pad support is integrally formed with the one-piece handle incorporating the hook engaging portion, each of a plurality of identically configured extraction devices exhibiting a variable clearance between the downwardly angled and pointed end of the engaging portion and the supporting portion and being incorporated into a kit assembly. In a second embodiment, the hook engaging and pad supporting portions are integrated together into a plurality of secondary components according to varying clearances and which are selectively interengaged with a common handle component. In a third embodiment, the hook portion is likewise incorporated into a second component engaged with a first handle component, whereas the pad support defines a yet further third component seated in linearly adjustable fashion within an elongated pocket defined in a modified forward location of the first handle component, further such that the pad support can be readjusted in positions both towards and away from a pointed and downwardly angled end associated with the hook engaging portion.

In use, an extraction device is selected according to a desired clearance (e.g. 12, 34, 16 mm) established between the pointed tip of the hook portion and the widthwise extending pad support, this corresponding to the dimensions of the patient's tooth to be removed. The device is manipulated such that the hook portion is first positioned along an inward (lingual) facing surface of a tooth to be removed (such as at or just below the gum line). The pad support is further adjusted (or readjusted) such that it abuts an opposite and outward facing (buccal) surface of the selected tooth, following which the handle is manipulated by the user (dentist or oral surgeon) by rotating downwardly (for a lower jaw tooth removal) or upwardly (for an upper jaw tooth removal), for quickly and efficiently enabling a dental professional to remove a patient's tooth or root tip.

### BACKGROUND OF THE INVENTION

Dental plier designs are known in the art and which provide the ability to apply significant leverage to a patient's mouth in the removal of teeth and root tips. A first example of such a plier design is set forth in U.S. Pat. No. 6,910,890, issued to Golden, and which teaches a dental plier appliance and associated method for removing teeth from a patient's gum line and bone. First and second handles are provided, each including a user grasping portion. The first handle terminates in an arcuately extending jaw exhibiting a substantially pointed end, the second handle terminates in an opposing and offset support exhibiting a support surface with an ergonomic configuration substantially matching that of the patient's gum line. Upon applying the support along a selected location below the gum line, and further aligning the jaw in abutting fashion against an inwardly facing side of a tooth and a penetrating distance beneath the gum line, the offset support defines a center point of rotation proximate to an edge location of the gum line and bone. The handles are subsequently rotated in an outward fashion away from the patient's gum line to forcibly dislodge the tooth from the patient's gum line and bone.

Beyond the two-handled design set forth in the 6,910,890 patent, a further example of a single handled tooth extractor is disclosed in U.S. Pat. No. 4,230,454, issued to Lococo, and which teaches a dentistry kit for tooth extraction consisting of a vise-type grip member having a joint member engaged by a forked end of a lever whose convexly curved fulcrum surface rests against a planar base plate located on teeth adjacent to the extracted tooth. The connection between the grip member and the lever is thus of the type generally resembling an angularly loose swivel joint. The grip member further includes two hemispherical tips, for engaging correspondingly shaped indentations drilled in the buccal and lingual sides of the tooth and which, upon being connected to the lever portion of the handle, establishing a pull force which is changed by displacing the point of contact between the fulcrum and the base plate.

### SUMMARY OF THE INVENTION

More specifically, the present invention teaches an extraction device exhibiting a single handle body terminating at an end location in a hooked engaging portion which exhibits a generally beak shape. In a first embodiment, a widthwise extending pad support is integrally formed with the one-piece handle incorporating the hook engaging portion, each of a plurality of identically configured extraction devices exhibiting a variable clearance between the downwardly angled and pointed end of the engaging portion and the supporting portion and being incorporated into a kit assembly. In a second embodiment, the hook engaging and pad supporting portions are integrated together into a plurality of second components according to varying clearances and which are selectively interengaged with a single first handle component. In a third embodiment, the hook portion is likewise incorporated into a second component engaged with a first handle component, whereas the pad support defines a yet further third component seated in linearly adjustable fashion within an elongated pocket defined in a modified forward location of the first handle component, further such that the pad support can be readjusted in positions both towards and away from a pointed and downwardly angled end associated with the hook engaging portion.

In use, an extraction device is selected according to a desired clearance (e.g. 12, 14, 16 mm) established between the pointed tip of the hook portion and the widthwise extending pad support, this corresponding to the dimensions of the patient's tooth to be removed. The device is manipulated such that the hook portion is first positioned along an inward (lingual) facing surface of a tooth to be removed (such as at or just below the gum line). The pad support is further adjusted (or readjusted) such that it abuts an opposite and outward facing (buccal) surface of the selected tooth, following which the handle is manipulated by the user (dentist or oral surgeon) by rotating downwardly (for a lower jaw tooth removal) or upwardly (for an upper jaw tooth removal), for quickly and efficiently enabling a dental professional to remove a patient's tooth or root tip.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of an oral extraction device according to a first embodiment a widthwise extending pact support is integrally formed with the one-piece handle incorporating the hooked engaging portion:

FIG. 2 is a plan view of the oral extraction device shown in FIG. 1;

FIG. 3 is a front view of the oral extraction device shown in FIG. 2;

FIG. 4 is an illustration of a plurality of identically configured extraction devices exhibiting variable clearances between the downwardly angled and pointed tip of the engaging portion and the widthwise extending and pad supporting portion, and such as which are incorporated into a kit assembly;

FIG. 5 is an exploded illustration of a second embodiment in which a hook engaging and pad supporting portion are combined into a plurality of secondary components according to varying clearances and which are selectively interengaged with a common handle component;

FIG. 6 is an assembled perspective of the variant of FIG. 5;

FIG. 7 is an exploded illustration of a third embodiment in which the hook portion is likewise incorporated into a second component engaged with a first handle component, whereas the pad support defines a yet further third component seated in linearly adjustable fashion within an elongated pocket defined in a modified forward location of the first handle component, further such that the pad support can be readjusted in positions both towards and away from a pointed and downwardly angled end associated with the hook engaging portion; and

FIG. 8 is an assembled perspective of the variant of FIG. 7.

### DETAILED DESCRIPTION OF THE PREFERRED EMBODIMENTS

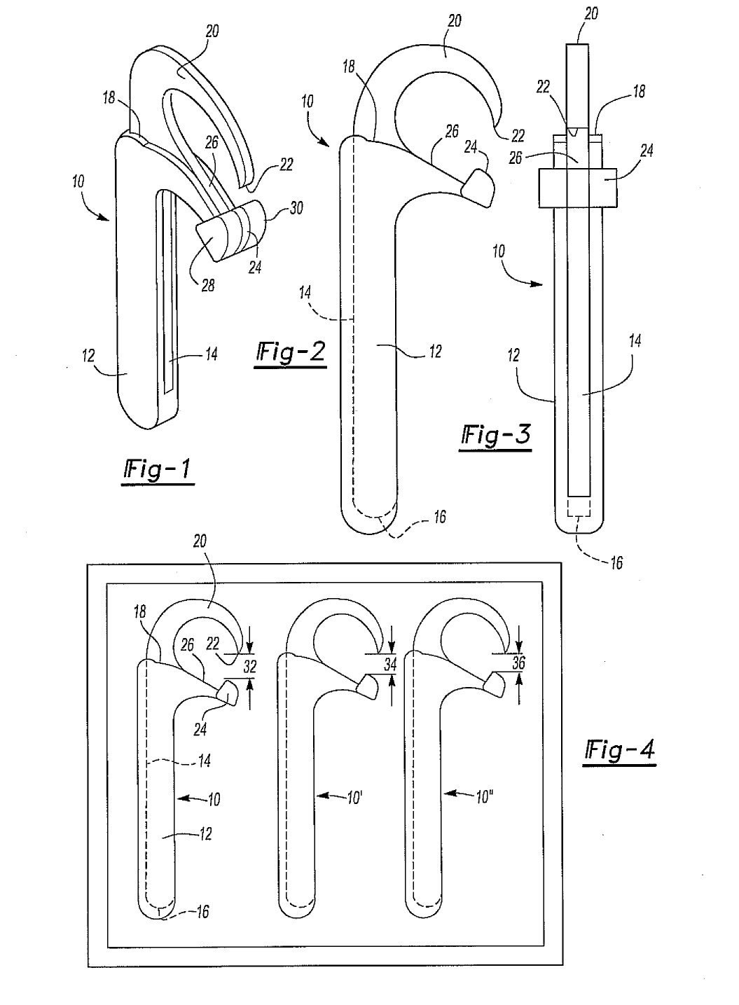

Referring now to FIGS. 1-4, a series of perspective and plan views are illustrated of an oral extraction device 10 according to a first preferred embodiment of the present invention. As previously described, the present invention discloses a single handle extraction device for removing teeth and root tips (not shown) and which is anchored within either of a lower or upper bridge, the associated tooth illustrating respective buccal (outward) and lingual (inward) facing surfaces.

As will be disclosed in additional detail with reference to the multiple embodiments disclosed herein, the extraction device exhibits an elongated grasping portion in the form of a single handle of desired and non-limiting configuration and which, beyond which is illustrated, can further exhibit, any desired ergonomic or other configuration. In particular, the handle can be designed for the removal of either upper and/or lower teeth or root tips, the associated handle configuration further contemplating specialized reconfigurations for addressing such as upper right, upper left, lower right, lower left positioned teeth, as well as general left hand or right hand variants according to the preference of the user.

An outermost layered covering, such as of a nylon, or polymer grade material is shown at 12 extending a specified distance along a one-piece handle 14 from a bottom edge 16 to a generally upper directed end location corresponding to a transitioning portion 18 of the handle, this leading to a hook shaped engaging portion, further shown at 20 and terminating in an inwardly/downwardly angled and pointed tip 22. The outermost covering 12 exhibits a specified degree of elasticity and gripability for ease and sureness of handling.

A widthwise extending pad support 24 is integrally formed with the one-piece handle 14 and extends via an interconnecting neck 26 from an upper location such that the pad support surface is arrayed in a predetermined spaced and opposing distance relative to the pointed tip 22 of the hook engaging portion 20. As shown, the one piece handle 14 with hook engaging portion 20 and pad support portion 24 can be produced from such as metal stamping exhibiting a generally flattened profile (with the exception of the widthwise extending pad support surface), however may also contemplate other materials, such as a high strength, high durability sanitary plastic. The outer applied covering 12 is further configured so that it can (optionally) extend over the interconnecting neck 26 and to opposite sides, at 28 and 30 as shown in FIG. 1, of the pad support 24.

As further shown in FIG. 4, each of a plurality of substantially identically configured oral extraction devices, see at 10, 10′ and 10″ are illustrated in a kit arrangement and which exhibit a variable clearance between the downwardly angled and pointed tip 22 of the engaging portion 20 and the pad supporting portion 24. In one non-limiting example, clearances 32, 34, and 36 associated with devices 10, 10′ and 10″ can exhibit such as 12, 14, and 16 mm gaps, these being understood to accommodate a majority of a range of generally known human teeth and root tips.

It is also understood and envisioned that additional pluralities of devices can be incorporated into the kit assembly, these exhibiting additional clearances (such as 11, 13, 15, mm). The present invention further contemplates providing differently sized kits for accommodating such as veterinary practices in the removal of teeth for larger sized animals.

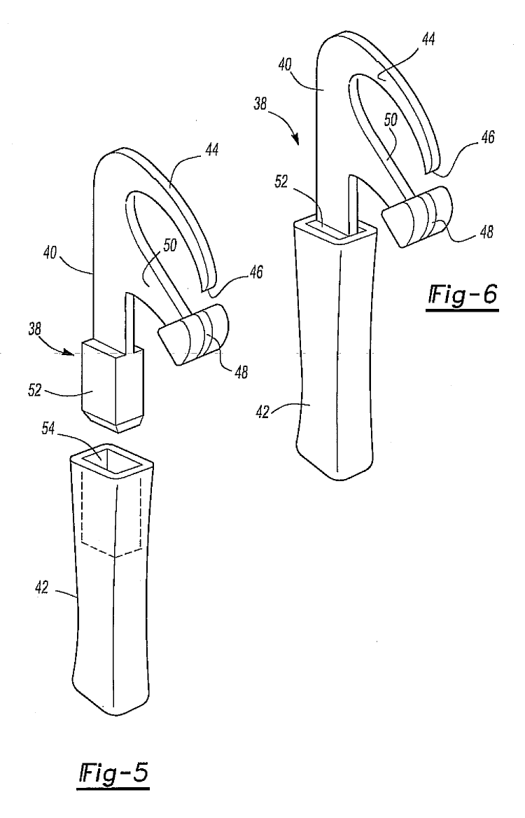

Referring now to FIGS. 5 and 6 both exploded and assembled perspective illustrations are shown of an oral extraction tool according to a second preferred embodiment 38 of a second embodiment in which both hook engaging and pad supporting portions are combined into a separate and secondary component, see at 40, this being releasably interengaged or interfitted with a common handle component 42. The engageable component 40 is constructed similar to the handle 14 in the first disclosed embodiment, such as from a high grade stainless steel stamping or suitable sanitary plasticized material, and exhibits a hook engaging portion 44 with a downwardly angled and pointed tip 46. The handle 42 is likewise constructed from such as a hardened plastic or other suitable material exhibiting desired gripping and non-slip properties.

A widthwise extending and configured pad support 48 is arrayed a desired spaced distance relative to the pointed tip 46 of the hook engaging portion via an interconnecting neck 50. A bottommost socket engaging portion 52 is provided and seats, such as in resistively interfitting fashion, within a receiving cavity 54 (FIG. 5) defined in the handle 42. Although not shown, a plurality of secondary components 40 can be provided according to varying clearances (such as illustrated in FIG. 4) and which are selectively interengaged with the common handle 42.

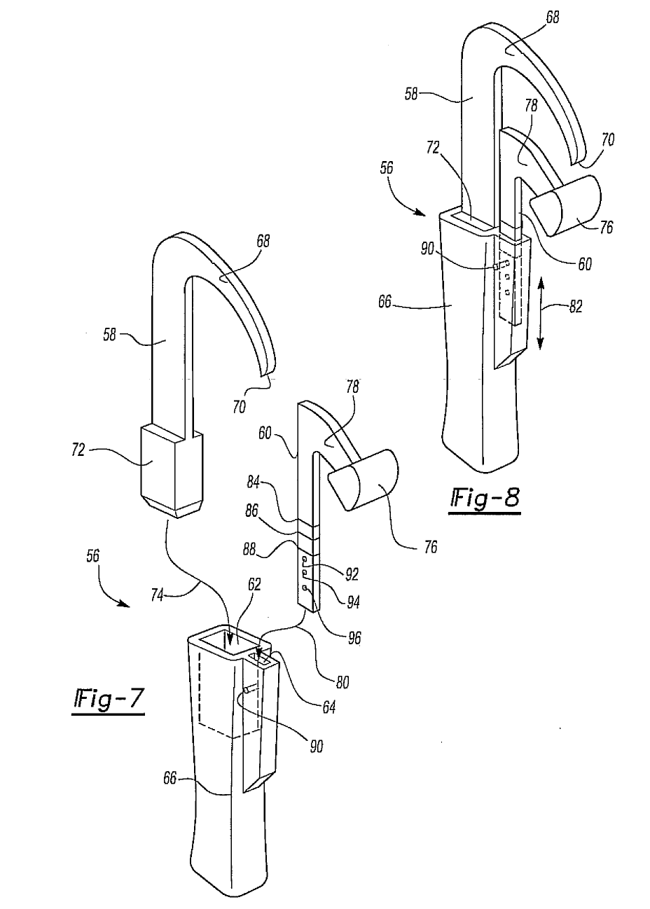

Referring finally to FIGS. 7 and 8, exploded and assembled perspective illustrations are provided of a third embodiment of oral extraction device 56, and in which the hook and pad support are broken into individual subset components, see at 58 and 60, these being secured in a likewise interengaging or resistive interfitting fashion within reconfigured receiving cavities 62 and 64 incorporated into a handle 66. The hook component 58 exhibits (similar to the corresponding elements in the previously described embodiments) a rounded upper beak 68 terminating in a downwardly angled and pointed tip 70. A bottommost socket engaging portion 72 (similar to the illustrated at 52 in FIG. 5) is further shown in FIG. 7 and is resistively fitted into the receiving cavity 62, and as further referenced by arrow 74.

The pad component 60 defines a third component with a linearly extending and relatively narrow cross section stem. A widthwise extending pad support surface 76 is integrally formed with the stem of the pad component 60, and again interconnected such as by a neck 78. The pad support stem inserted into the elongated receiving cavity (or pocket) 64, see arrow 80 in FIG. 7.

As further shown in FIG. 8, the pad support stem 60 is seated in linearly adjustable fashion within the elongated pocket 64 defined at a modified forward location of the handle component 66, further such that the pad support can be readjusted in positions both towards and away from the pointed and downwardly angled tip 70 associated with the hook engaging portion 68, see also multi-directional arrow 82 in FIG. 8. Although not shown, it is understood that a lowermost location of the stem, see as referenced by markings 84, 86, and 88 in FIG. 7, these defining desired spatial clearances (e.g. corresponding to 12, 14, 16 mm) with the opposing hook portion tip 70, and upon seating the stem within its associated elongated cavity (or pocket) 64. It. is also understood that the stem can be resistively interfitted within the cavity 64, in the manner illustrated in FIG. 8 or, alternatively, a pin or catch element of given construction, see as representatively illustrated at 90 in FIG. 8, extending through an exterior location of the pocket 64 defined in the handle 66 and into one of a plurality of spaced apart receiving locations proximate to a bottom (see at 92, 94 and 96) of the stem. Similar to that disclosed in the second embodiment of FIGS. 5 and 6, more than one pad support 60 and/or more than one hook component 58 can be interfittingly engaged with the handle 66 and in order to configure any desired clearance between the hook pint 70 and configured pad support surface 76.

In use, an extraction device is selected according to a desired clearance (e.g. 12, 14, 16 mm) established between the pointed tip of the hook portion and the widthwise extending pad support, this corresponding to the dimensions of the patient's tooth to be removed. The device is manipulated such that the hook portion is first positioned along an inward (lingual) facing surface of a tooth to be removed (such as at or just below the gum line). The pad support is further adjusted (or readjusted) such that it abuts an opposite and outward facing (buccal) surface of a patient's bridge, typically a distance below or above the selected tooth, following which the handle is manipulated by the user (dentist or oral surgeon) by rotating downwardly (for a lower jaw tooth removal) or upwardly (for an upper jaw tooth removal), for quickly and efficiently enabling a dental professional to remove a patient's tooth or root tip.

The re-adjustability aspects of the present invention, combined into a single handled dental lever-type extraction tool, can additionally facilitate ease of readjustment in mid-extraction of teeth or root tips, such usually being required to finesse the engagement locations against the tooth or root tip, and following an initial rotating displacement but prior to a completed removal. The ability to easily readjust the instrument during mid-extraction provides the user with the increased ability to quickly and more painlessly remove the tooth, without damage to the same or the surrounding bridge or gum line, than is possible with more conventional tools which require more effort in the way of manipulation or the requirement that multiple tools be employed in the removal of the tooth/root tip (this again increasing the effort and time for removing).

It is also envisioned that the hook and pad support can be reversed in position, such that the pad can contact the lingual surface, with the hook portion engaging a tooth location associated with the buccal surface and by which inward rotation of the device results in tooth/root tip removal.

The one-handled device according to the present design further accomplishes the objective of avoiding the heretofore requirement of the dental professional having to leverage two handles during the extraction procedure. An undesirable consequence of this requirement is the amount of force and pressure applied against the tooth by a conventional two handled plier design, this resulting in both damage to the tooth and the surrounding areas of the patient's gum line and possibly bridge, as well as the increased amount of pain inflicted upon the patient, and by virtue of a non-optimal extraction protocol being implemented during tooth removal.

Having described our invention, other and additional preferred embodiments will become apparent to those skilled in the art to which it pertains, and without deviating from the scope of the appended claims.

We claim:

1. An oral extraction device, comprising:
an elongated handle communicating with a hook portion for engaging a first surface associated with at least one of a tooth and a root tip; and
a pad support arrayed a spaced distance relative to said hook portion and for engaging a second surface associated with a dental bridge supporting said tooth or root tip;
said extraction device adapted for one-handed positioned and repositioning by a user prior to and during extraction of the tooth or root tip.

2. The device according to claim 1, further comprising an outermost layered covering secured over at least said handle.

3. The device according to claim 2, said layered covering further comprising at least one of a nylon or a polymer grade material extending a specified distance along said handle to a generally upper directed end location corresponding to a transitioning portion with said hook portion.

4. The device according to claim 1, said pad support further comprising a widthwise extending surface integrally formed with said handle and extending, via an interconnecting neck, and such that a pad support surface is arrayed in a predetermined spaced and opposing distance relative to a pointed tip of said hook portion.

5. The device according to claim 4, further comprising said handle, hook portion and pad support being produced as one piece stamping.

6. The device according to claim 5, further comprising a plurality of substantially identically configured oral extraction devices incorporated into a kit arrangement, each of said devices exhibiting a variable spacing between said pointed tip and said pad support surface.

7. The device according to claim 6, further comprising a range associated with said variable spacing corresponding to 12-16 mm.

8. The device according to claim 1, further comprising said hook portion and said pad support being combined into a secondary component which is releasably engaged with said handle.

9. The device, according to claim 8, said secondary component further comprising a bottommost socket engaging portion seating in resistively interfitting fashion within a receiving cavity defined in said handle.

10. The device according to claim 9, further comprising a plurality of secondary components, each establishing a predetermined spaced and opposing distance between a support surface associated with said pad support and a pointed tip of said hook portion.

11. The device according to claim 1, further comprising said hook portion and said pad support being provided as individual subset components and which are releasably engaged within first and second receiving cavities incorporated into said handle.

12. The device according to claim 13, a secondary component corresponding to said hook portion further comprising a bottommost socket engaging portion seating in resistively interfitting fashion within said first receiving cavity defined in said handle.

13. The device according to claim 11, a secondary component corresponding to said pad component further comprising a linearly extending and relatively narrow cross section stem, a widthwise extending support surface being integrally formed with said stem via an interconnecting neck.

14. The device as described in claim 13, further comprising said stem being linearly adjustable within said elongated receiving cavity such that said pad support surface can be readjusted in positions both towards and away from a pointed tip of said hook portion.

15. The device as described in claim 14, a lowermost location of the stem further comprising reference markings which, upon translating said stem to a desired position within said elongated cavity, defines a desired spatial clearance between said pad support surface and said tip of said hook portion.

16. The device as described in claim 15, further comprising an insertable pin extending through an exterior location of said elongated cavity and into one of a plurality of spaced apart receiving locations proximate a bottom of said stem.

17. The device as described in claim 11, further comprising a plurality of subset components individually engaged with said handle to establish a predetermined spaced and opposing distance between a support surface associated with said pad support and a pointed tip of said hook portion.

18. An oral extraction device, comprising:
an elongated handle communicating with a hook portion for engaging a lingual surface associated with at least one of a tooth and a root tip;
a pad support arrayed a spaced distance relative to said hook portion and for engaging a buccal surface associated with a dental bridge supporting said tooth or root, tip, said pad support further comprising a widthwise extending surface integrally formed with said handle and extending, via an interconnecting neck such that a pad support surface is arrayed in a predetermined spaced and opposing distance relative to a pointed tip of said hook portion; and
said handle, hook portion and pad support being produced as one piece stamping and over which is applied a grip enhancing covering material.

19. The device according to claim 18, further comprising a plurality of substantially identically configured oral extraction devices incorporated into a kit arrangement, each of said devices exhibiting a variable spacing between said pointed tip and said pad support surface.

20. An oral extraction device, comprising:
an elongated handle communicating with a hook portion for engaging a lingual surface associated with at least one of a tooth and a root tip;
a pad support arrayed a spaced distance relative to said hook, portion and for engaging a buccal surface associated with a dental bridge supporting said tooth or root tip, said pad support further comprising a widthwise extending surface integrally formed with said handle and extending, via an interconnecting neck such that a pad support surface is arrayed in a predetermined spaced and opposing distance relative to a pointed tip of said hook portion; and
said hook portion and said pad support being combined into a secondary component which is releasably engaged with said handle, said secondary component further comprising a bottommost socket engaging portion seating in resistively interfitting fashion within a receiving cavity defined in said handle.
